(19) United States
(12) Patent Application Publication
(10) Pub. No.: US 2019/0311455 A1
(43) Pub. Date: Oct. 10, 2019

(54) SCHEDULED PASSENGER GUIDANCE DEVICE, SCHEDULED PASSENGER GUIDANCE METHOD, AND PROGRAM RECORDING MEDIUM

(71) Applicant: NEC Solution Innovators, Ltd., Koto-ku, Tokyo (JP)

(72) Inventors: Yukihiro MIIKE, Tokyo (JP); Kenji EGOSHI, Tokyo (JP); Hiroaki OHURA, Tokyo (JP)

(73) Assignee: NEC Solution Innovators, Ltd., Koto-ku, Tokyo (JP)

(21) Appl. No.: 16/467,557

(22) PCT Filed: Dec. 15, 2017
(86) PCT No.: PCT/JP2017/045057

§ 371 Date: Jun. 7, 2019

(30) Foreign Application Priority Data
Dec. 22, 2016 (JP) 2016-249893

(51) Int. Cl. G06Q 90/00; H04W 4/024; G06Q 50/30

(52) U.S. Cl. CPC G06Q 90/20; G06Q 50/30; H04W 4/024

(57) ABSTRACT

A scheduled passenger guidance device includes: a flight number acquisition unit acquiring a flight number scheduled to be boarded by a scheduled passenger; a flight information acquisition unit acquiring flight information about each airport; a position information acquisition unit acquiring position information about a terminal device; a boarding time acquisition unit acquiring a boarding time of an aircraft scheduled to be boarded by the scheduled passenger from the flight information based on a flight number acquired by the flight number acquisition unit; and a notification unit providing, for the terminal device, a notification urging the scheduled passenger to board the aircraft, according to the boarding time and position information about the terminal device.

### TECHNICAL FIELD

The present invention relates to a device and a method that guide a traveler who uses an aircraft to an airport, and a program recording medium for achieving the device and the method.

### BACKGROUND ART

A traveler who uses an aircraft is required to pass through a safety inspection station and a boarding gate in a terminal building at an airport before a predetermined time (for example, 15 minutes and 10 minutes before a departure time).

However, a traveler who is not used to using an aircraft is also included among travelers who use an aircraft. For such a reason, as also described in NPL 1, for example, a situation where many travelers miss an aircraft occurs.

Thus, a system for preventing a missed aircraft as described above is developed. For example, RFID tag information about a scheduled passenger is read by an RFID tag reader installed at an airport in a traveler boarding guidance system disclosed in PTL 1. Alarm information is transmitted from the RFID tag reader by which the RFID tag information is read to a scheduled passenger (non-boarded passenger) who is not yet on board just before a departure. In this way, the non-boarded passenger can become aware of his/her own delay in boarding and can head for a boarding gate.

### CITATION LIST

### Patent Literature

[PTL 1] Japanese Unexamined Patent Application Publication No. 2008-181301

[PTL 2] Japanese Unexamined Patent Application Publication No. H10 (1998)-111893

[PTL 3] Japanese Unexamined Patent Application Publication No. 2000-035997

### Non Patent Literature

[NPL 1] “ITmedia Business Online Wednesday Interview Theater, What Kind of Person Who Is the Last to Board Airplane, Analysis at Haneda Airport”, [online], [Searched on Oct. 6, 2016], Internet <http://www.itmedia.co.jp/business/articles/1605/11/news013_5.html>

### SUMMARY OF INVENTION

### Technical Problem

It is conceivable that a traveler who arrives at an airport can be appropriately guided to a boarding gate by using a technique of PTL 1. In this way, a traveler can be conceivably prevented from missing an aircraft.

Although the technique of PTL 1 can guide a traveler who arrives at an airport to a boarding gate, a traveler who does not arrive at an airport cannot be guided to a boarding gate. Thus, even when the technique of PTL 1 is used, a traveler who is not used to using an aircraft needs to head for an airport with time to spare, in time for a departure time of an aircraft.

However, it is realistically difficult for all travelers to head for an airport with time to spare. Even when the technique of PTL 1 is used, a traveler may not be prevented from missing an aircraft.

One example of an object of the present invention is to provide a scheduled passenger guidance device, a scheduled passenger guidance method, and a program recording medium being capable of appropriately guiding a scheduled passenger of an aircraft to an airport.

### Solution to Problem

To achieve the above object, a scheduled passenger guidance device of an aspect of the present invention is a scheduled passenger guidance device that guides a scheduled passenger of an aircraft to an airport, and the scheduled passenger guidance device includes:

a flight number acquisition unit that acquires information on a flight number of an aircraft scheduled to be boarded by the scheduled passenger, the flight number being input from a terminal device;

a flight information acquisition unit that acquires flight information including information on flight numbers and boarding times of a plurality of aircrafts for each airport;

a position information acquisition unit that acquires position information on the terminal device;

a boarding time acquisition unit that acquires information on a boarding time of the aircraft scheduled to be boarded by the scheduled passenger using the information on the flight number of the aircraft acquired by the flight number acquisition unit and the flight information acquired by the flight information acquisition unit; and

a notification unit that provides a notification for the terminal device, the notification urging the scheduled passenger to board an aircraft and being based on the information on the boarding time acquired by the boarding time acquisition unit and the position of the terminal device acquired by the position information acquisition unit.

To achieve the above object, a scheduled passenger guidance method of an aspect of the present invention is a scheduled passenger guidance method for guiding a scheduled passenger of an aircraft to an airport, and the scheduled passenger guidance method includes:

acquiring information on a flight number of an aircraft scheduled to be boarded by the scheduled passenger, the flight number being input from a terminal device;

acquiring flight information including information on flight numbers and boarding times of a plurality of aircrafts for each airport;

acquiring position information on the terminal device;

acquiring information on a boarding time of the aircraft scheduled to be boarded by the scheduled passenger using the information on the flight number of the aircraft and the flight information; and

providing a notification for the terminal device, the notification urging the scheduled passenger to board an aircraft and being based on the information on the boarding time and the position of the terminal device.

To achieve the above object, a program recording medium of an aspect of the present invention is a program recording medium recording a computer program that makes a computer guide a scheduled passenger of an aircraft to an airport. The computer program causes the computer to execute:

acquiring information on a flight number of an aircraft scheduled to be boarded by the scheduled passenger, the flight number being input from a terminal device;

acquiring flight information including information on flight numbers and boarding times of a plurality of aircrafts for each airport;

acquiring position information on the terminal device;

acquiring information on a boarding time of the aircraft scheduled to be boarded by the scheduled passenger using the information on the flight number of the aircraft and the flight information; and

providing a notification for the terminal device, the notification urging the scheduled passenger to board an aircraft and being based on the information on the boarding time and the position of the terminal device.

### Advantageous Effects of Invention

According to the present invention described above, a scheduled passenger of an aircraft can be appropriately guided to an airport.

### BRIEF DESCRIPTION OF DRAWINGS

FIG. 1 is a block diagram illustrating a schematic configuration of a guidance device according to an example embodiment of the present invention.

FIG. 2 is a block diagram illustrating a specific configuration of the guidance device according to the example embodiment of the present invention.

FIG. 3 is a diagram illustrating one example of a route to a boarding gate displayed on a display screen of a terminal device.

FIG. 4 is a flowchart illustrating an operation of the guidance device according to the example embodiment of the present invention.

FIG. 5 is a flowchart illustrating an operation of the guidance device according to the example embodiment of the present invention.

FIG. 6 is a block diagram illustrating a configuration of a guidance device according to a modification example.

FIG. 7 is a block diagram illustrating one example of a computer that achieves the guidance device according to the example embodiment of the present invention.

### EXAMPLE EMBODIMENT

### Example Embodiment

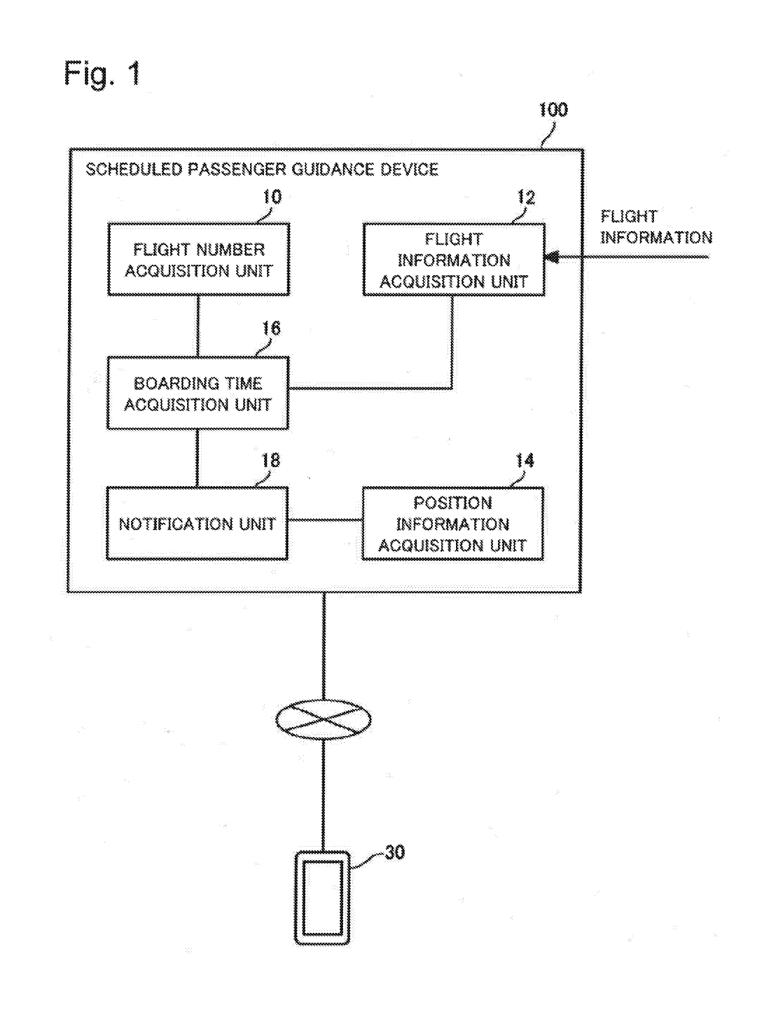

Hereinafter, a scheduled passenger guidance device, a scheduled passenger guidance method, and a program according to an example embodiment of the present invention are described with reference to FIGS. 1 to 7.

### [Device Configuration]

First, a schematic configuration of the scheduled passenger guidance device (hereinafter, also simply referred to as a guidance device) according to the example embodiment of the present invention is described using FIG. 1. FIG. 1 is a block diagram illustrating the schematic configuration of the guidance device according to the example embodiment of the present invention.

As illustrated in FIG. 1, the guidance device 100 according to the present example embodiment includes a flight number acquisition unit 10, a flight information acquisition unit 12, a position information acquisition unit 14, a boarding time acquisition unit 16 and a notification unit 18. The guidance device 100 is a device that guides a scheduled passenger of an aircraft to an airport. The guidance device 100 transmits and receives data to and from a terminal device 30 via the Internet. The terminal device 30 is used for a scheduled passenger of an aircraft. For example, a smartphone, a tablet type terminal, and the like are used as the terminal device 30.

The flight number acquisition unit 10 acquires a flight number of an aircraft (a flight number scheduled to be boarded by a scheduled passenger) input by the scheduled passenger using the terminal device 30. The flight information acquisition unit 12 acquires flight information including information on flight numbers and boarding times of a plurality of aircrafts for each airport. In the present example embodiment, the flight information acquisition unit 12 acquires the flight information about each airport from, for example, a flight information system (FIS).

The position information acquisition unit 14 acquires position information about the terminal device 30. Note that various known methods can be used as a method of acquiring position information. In the present example embodiment, for example, when a global positioning system (GPS) for measuring its own position is mounted on the terminal device 30, the position information acquisition unit 14 can acquire the position information about the terminal device 30 from the terminal device 30. Note that the position information acquisition unit 14 may acquire the position information about the terminal device 30 from, for example, a base station of a mobile communication network.

The boarding time acquisition unit 16 acquires a boarding time of an aircraft scheduled to be boarded by the scheduled passenger from the flight information acquired by the flight information acquisition unit 12, based on the flight number of the aircraft acquired by the flight number acquisition unit 10.

The notification unit 18 provides, to the terminal device 30, a notification that urges the scheduled passenger to board the aircraft based on the boarding time acquired by the boarding time acquisition unit 16 and the position information about the terminal device 30 acquired by the position information acquisition unit 14.

In such a manner, the guidance device 100 according to the present example embodiment provides the notification by the notification unit 18 based on the boarding time of the aircraft and the position information about the terminal device 30. In other words, in the present example embodiment, the guidance device 100 can urge the scheduled passenger to board the aircraft based on the boarding time of the aircraft and the position of the scheduled passenger. In this case, the scheduled passenger can be urged to board the aircraft at appropriate timing according to the position of the scheduled passenger, and thus the scheduled passenger can be appropriately guided to the airport.

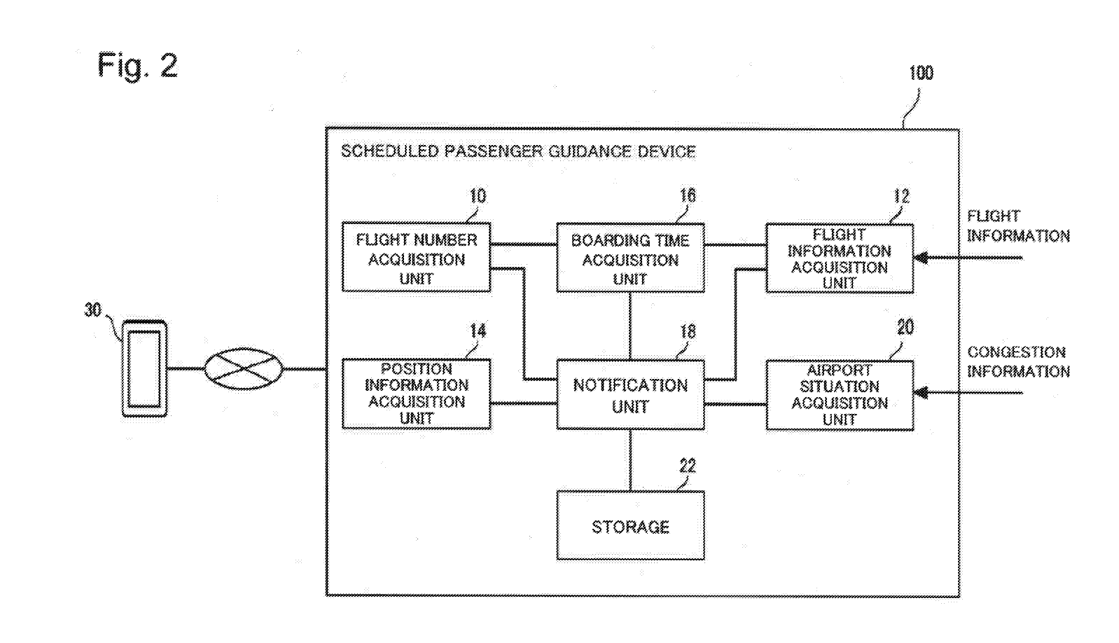

Next, a configuration and a function of the guidance device in the example embodiment of the present invention are more specifically described using FIG. 2. FIG. 2 illustrates a block diagram illustrating a specific configuration of the guidance device in the example embodiment of the present invention.

As illustrated in FIG. 2, in the present example embodiment, the guidance device 100 further includes an airport situation acquisition unit 20 and a storage 22 in addition to the flight number acquisition unit 10, the flight information acquisition unit 12, the position information acquisition unit 14, the boarding time acquisition unit 16 and the notification unit 18 which are described above.

As described above, the flight number acquisition unit 10 acquires the flight number scheduled to be boarded by the scheduled passenger. As described above, the flight information acquisition unit 12 acquires the flight information about each airport. In the present example embodiment, the flight information acquisition unit 12 acquires the flight information including the information on flight numbers of the plurality of aircrafts, the boarding time of each aircraft, vacant seat information about each aircraft, the position information about the airport at which each aircraft waits, and information about a boarding gate used by each aircraft. As described above, the position information acquisition unit 14 acquires the position information about the terminal device 30. As described above, the boarding time acquisition unit 16 acquires the boarding time of the aircraft scheduled to be boarded by the scheduled passenger.

The airport situation acquisition unit 20 acquires congestion information indicating a congestion situation of each airport. For example, the congestion information is generated for each airport and transmitted from each airport to the airport situation acquisition unit 20. The congestion information includes a waiting situation at a safety inspection station, and the like, for example.

The notification unit 18 calculates a distance between the airport at which the aircraft scheduled to be boarded by the scheduled passenger waits and a current position of the scheduled passenger based on the flight number of the aircraft acquired by the flight number acquisition unit 10, the flight information acquired by the flight information acquisition unit 12, and the position information acquired by the position information acquisition unit 14. Specifically, the notification unit 18 first acquires the position information about the airport at which the aircraft scheduled to be boarded by the scheduled passenger waits, from the flight information acquired by the flight information acquisition unit 12 based on the flight number of the aircraft acquired by the flight number acquisition unit 10. Then, the notification unit 18 calculates the distance between the airport and the scheduled passenger based on the acquired position information about the airport and the position information about the terminal device 30 acquired by the position information acquisition unit 14.

Further, the notification unit 18 notifies the terminal device 30 of a time at which the scheduled passenger needs to depart for the airport from the current position (hereinafter, described as a departure time) according to the calculated distance. In this way, the scheduled passenger can be urged to board the aircraft.

Note that, for example, moving time information is stored in the storage 22 beforehand in the present example embodiment. The moving time information indicates a relationship between the calculated distance from the airport and the time required for the scheduled passenger to move the distance and arrive at the airport. The notification unit 18 calculates a time required for the scheduled passenger to arrive at the airport (hereinafter, described as a moving time) based on the calculated distance and the moving time information stored in the storage 22. Then, the notification unit 18 calculates a departure time of the scheduled passenger based on the calculated moving time, and notifies the terminal device 30 of the departure time.

Note that the notification unit 18 corrects the departure time of the scheduled passenger based on the congestion information acquired by the airport situation acquisition unit 20 in the present example embodiment. For example, the notification unit 18 advances the departure time of the scheduled passenger to be notified to the terminal device 30 according to the congestion situation at the airport at which the aircraft scheduled to be boarded by the scheduled passenger waits. In the present example embodiment, the notification unit 18 corrects the departure time to be notified to the terminal device 30 based on a relationship between the congestion situation and a correction time stored in the storage 22 beforehand. In this way, the scheduled passenger can depart for the airport at an appropriate time according to the congestion situation at the airport.

Further, the notification unit 18 determines whether a delay occurs for the aircraft scheduled to be boarded by the scheduled passenger based on the flight information acquired by the flight information acquisition unit 12 in the present example embodiment. Then, when the delay occurs, the notification unit 18 notifies the terminal device 30 of a flight number and a boarding time of another aircraft having a vacant seat based on the flight information acquired by the flight information acquisition unit 12. In this way, the scheduled passenger can cancel the aircraft scheduled to be boarded for which the delay has occurred, and make a reservation for another aircraft. Note that detailed description is omitted, but the notification unit 18 may notify the terminal device 30 of the departure time to board the another aircraft.

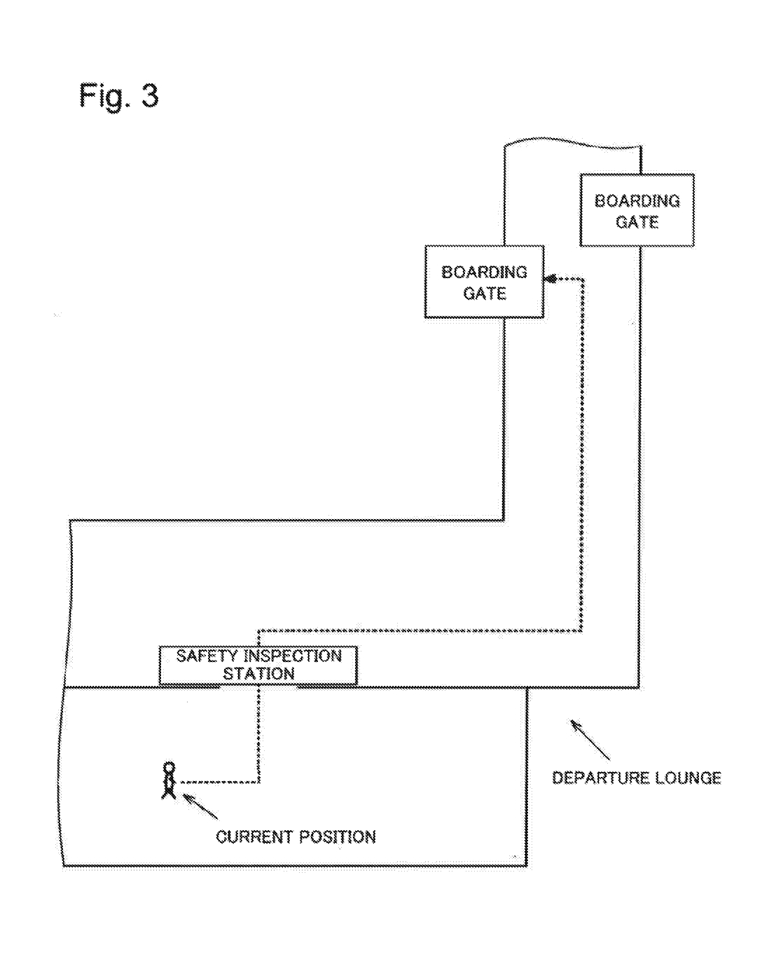

Further, the notification unit 18 determines whether the scheduled passenger has arrived at the airport based on the position information acquired by the position information acquisition unit 14 in the present example embodiment. Then, when the scheduled passenger has arrived at the airport, the notification unit 18 notifies the terminal device 30 of a route from a current position of the scheduled passenger to the boarding gate used by the aircraft scheduled to be boarded in a terminal building based on a floor map of the terminal building at the airport preregistered in the storage 22, the flight information (information about the boarding gate) acquired by the flight information acquisition unit 12, and the position information acquired by the position information acquisition unit 14. Specifically, as illustrated in FIG. 3, for example, the notification unit 18 transmits data for displaying a route from a current position of the scheduled passenger to the boarding gate on a display screen of the terminal device 30. In this way, the scheduled passenger can smoothly move to the boarding gate. Note that the notification unit 18 may notify the scheduled passenger who has not arrived at the airport of the boarding gate and the route to the boarding gate.

### [Device Operation]

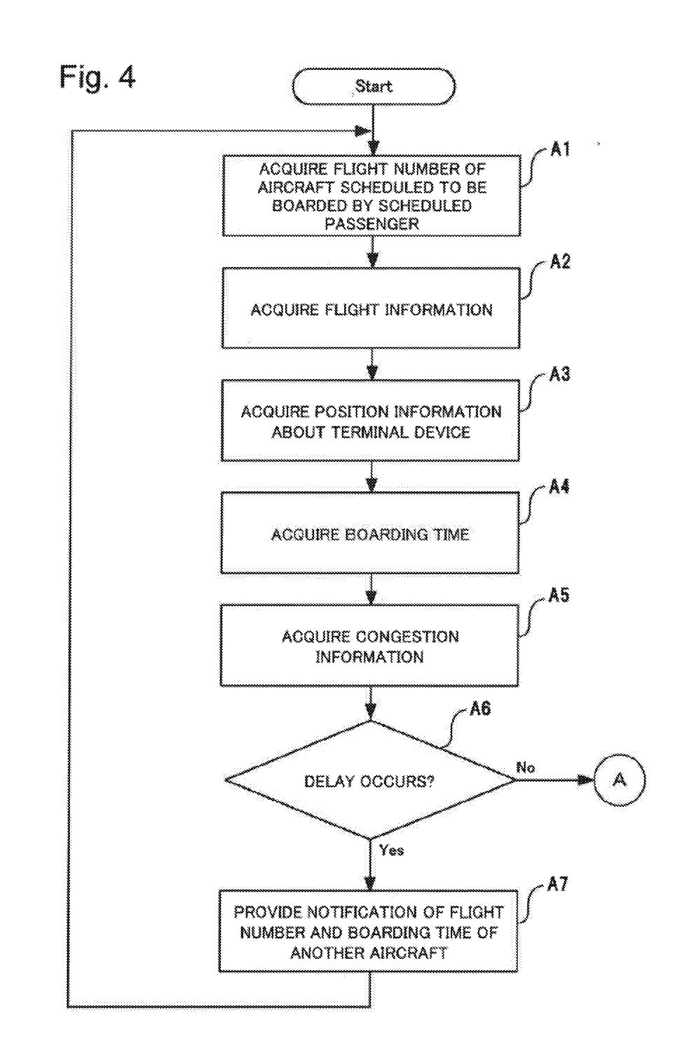

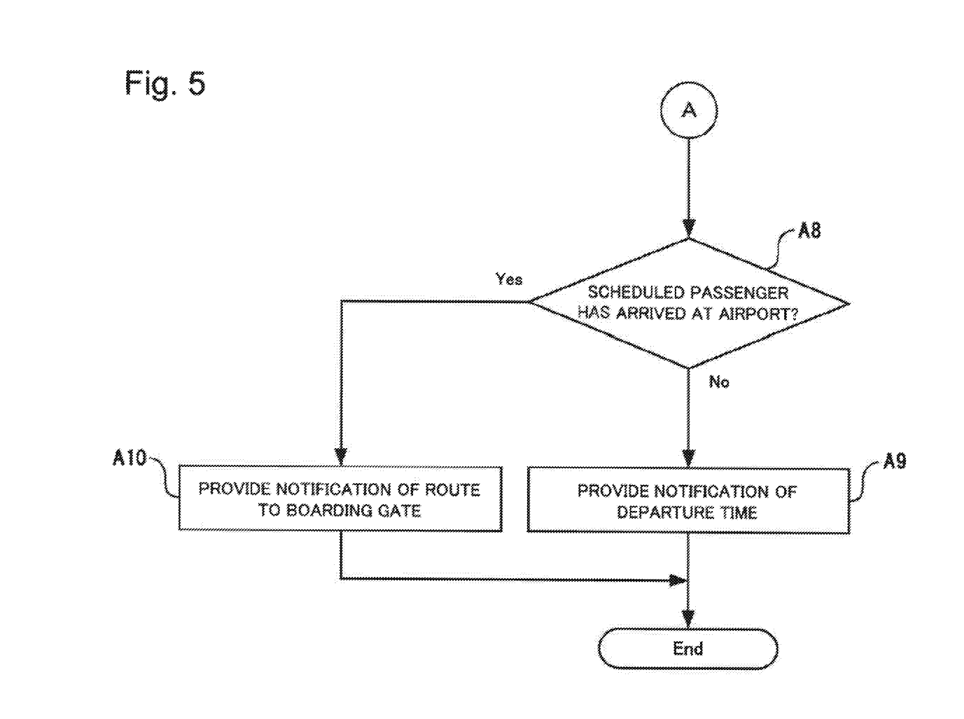

Next, an operation of the scheduled passenger guidance device in the example embodiment of the present invention is described by using FIGS. 4 and 5. FIGS. 4 and 5 are flowcharts each illustrating an operation of the scheduled passenger guidance device in the example embodiment of the present invention. In the following description, FIGS. 1 to 3 are appropriately considered. Further, a scheduled passenger guidance method is performed by operating the guidance device 100 in the present example embodiment. Thus, description of the scheduled passenger guidance method in the present example embodiment is replaced with the following operation description of the guidance device 100.

As illustrated in FIG. 4, in the guidance device 100, as described above, the flight number acquisition unit 10 acquires the flight number of the aircraft scheduled to be boarded by the scheduled passenger (Step A1). The flight information acquisition unit 12 acquires the flight information (Step A2). The position information acquisition unit 14 acquires the position information about the terminal device 30 (Step A3). The boarding time acquisition unit 16 acquires the boarding time of the aircraft scheduled to be boarded by the scheduled passenger (Step A4). The airport situation acquisition unit 20 acquires the congestion information (Step A5).

Next, as described above, the notification unit 18 determines whether the delay occurs for the aircraft scheduled to be boarded by the scheduled passenger (Step A6). When the delay occurs, the notification unit 18 notifies the terminal device 30 of the flight number and the boarding time of another aircraft having the vacant seat as described above (Step A7). Subsequently, the processing in Step A1 is performed again by the flight number acquisition unit 10. Note that, in Step A7, the notification unit 18 may notify the terminal device 30 of the departure time to board the another aircraft.

When the delay does not occur in Step A6, as illustrated in FIG. 5, the notification unit 18 determines whether the scheduled passenger has arrived at the airport (Step A8). When the scheduled passenger has not arrived at the airport, the notification unit 18 calculates the departure time of the scheduled passenger and notifies the terminal device 30 of the departure time as described above (Step A9). Note that, in Step A9, as described above, the notification unit 18 provides the notification of the departure time corrected according to the congestion situation at the airport. Further, in Step A9 in the present example embodiment, the notification unit 18 notifies the terminal device 30 of the boarding gate used by the aircraft scheduled to be boarded together with the departure time. Furthermore, when the boarding gate that has been notified once is changed, the notification unit 18 notifies the terminal device 30 of the boarding gate after the change.

When the scheduled passenger has arrived at the airport in Step A8, the notification unit 18 notifies the terminal device 30 of the route to the boarding gate as described above (Step A10).

### [Modification Example]

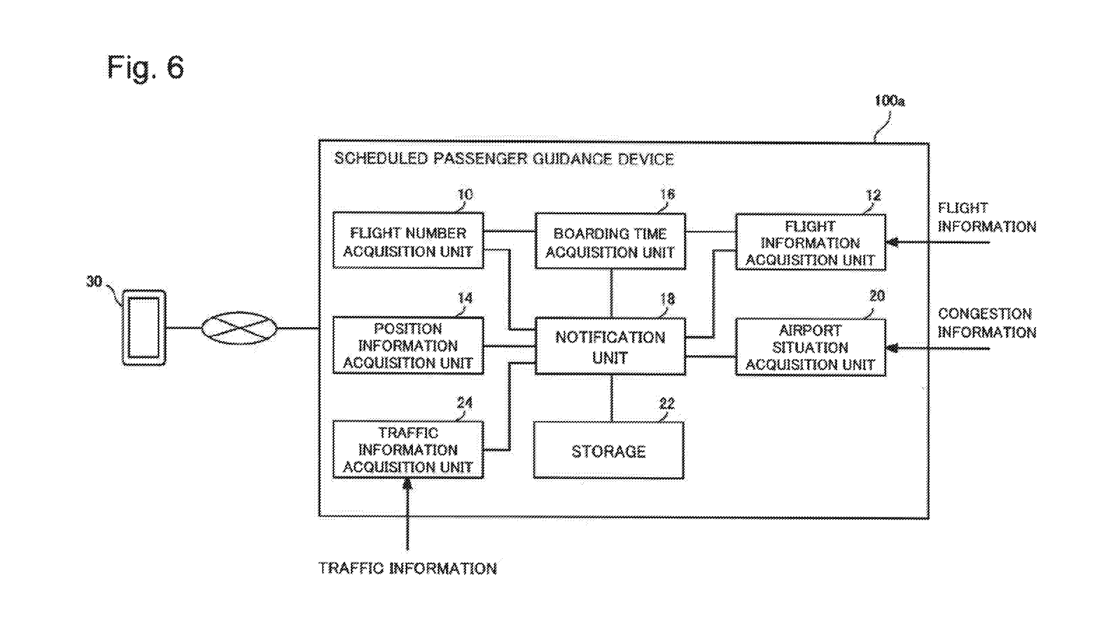

FIG. 6 is a block diagram illustrating a guidance device 100a according to a modification example in the present example embodiment. The guidance device 100a according to the modification example further includes a traffic information acquisition unit 24 in addition to the guidance device 100 described above. Note that only a portion of a configuration and a function of the guidance device 100a which is different from that of the guidance device 100 is described below.

The traffic information acquisition unit 24 acquires traffic information. The traffic information includes information related to a road situation, such as traffic jam information and restriction information, for example.

A notification unit 18 determines a traffic route from a current position of the scheduled passenger to the airport at which the aircraft scheduled to be boarded by the scheduled passenger waits based on the flight number of the aircraft acquired by the flight number acquisition unit 10, the flight information acquired by the flight information acquisition unit 12, the position information acquired by the position information acquisition unit 14 and the traffic information acquired by the traffic information acquisition unit 24.

Specifically, the notification unit 18 first acquires the position information about the airport at which the aircraft scheduled to be boarded by the scheduled passenger waits from the flight information acquired by the flight information acquisition unit 12 based on the flight number of the aircraft acquired by the flight number acquisition unit 10. Then, the notification unit 18 calculates a plurality of traffic routes from the current position of the scheduled passenger to the airport based on the acquired the position information about the airport and the position information about the terminal device 30 acquired by the position information acquisition unit 14, and notifies the terminal device 30 of the plurality of calculated traffic routes. In the present modification example, the notification unit 18 calculates the traffic route by taking traffic information (such as the traffic jam information) acquired by the traffic information acquisition unit 24 into consideration. Note that the traffic route can be calculated by various known methods, and thus detailed description is omitted.

In the present modification example, the notification unit 18 notifies the terminal device 30 of, for example, various pieces of information related to traffic, such as route information, transfer information, and operation information, in addition to a plurality of traffic routes. Further, the notification unit 18 calculates the departure time of the scheduled passenger for each calculated traffic route, and notifies the terminal device 30 of the calculated departure time. Note that, also in the guidance device 100a, the notification unit 18 notifies the terminal device 30 of the departure time corrected according to the congestion situation at the airport, similarly to the guidance device 100 described above.

In the present modification example, the plurality of traffic routes and the departure time calculated as mentioned above are notified to the terminal device 30 in Step A9 in FIG. 5.

### [Program]

A program in the example embodiment of the present invention may be a program causing a computer to perform Steps A1 to A10 illustrated in FIGS. 4 and 5. This program is installed on a computer and executed, whereby the scheduled passenger guidance device and the scheduled passenger guidance method in the present example embodiment can be achieved. In this case, a central processing unit (CPU) of the computer being the scheduled passenger guidance device functions as the flight number acquisition unit 10, the flight information acquisition unit 12, the position information acquisition unit 14, the boarding time acquisition unit 16, the notification unit 18, the airport situation acquisition unit 20, and the traffic information acquisition unit 24, and performs processing.

Further, the program according to the present example embodiment may be executed by a computer system constructed by a plurality of computers. In this case, for example, each of the computers may function as any one of the flight number acquisition unit 10, the flight information acquisition unit 12, the position information acquisition unit 14, the boarding time acquisition unit 16, the notification unit 18, the airport situation acquisition unit 20, and the traffic information acquisition unit 24. Further, the storage 22 may be constructed on a computer different from a computer that executes the program according to the present example embodiment.

### [Physical Configuration]

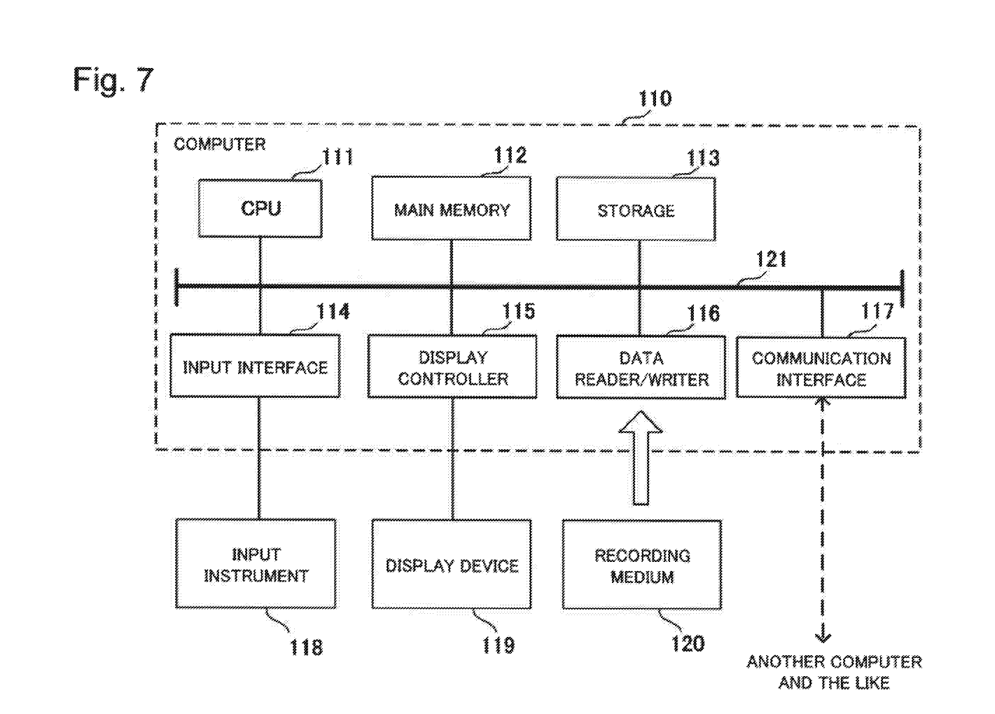

Herein, a computer that achieves the scheduled passenger guidance device by executing the program according to the present example embodiment is described by using a drawing. FIG. 7 is a block diagram illustrating one example of a computer that achieves the scheduled passenger guidance device according to the example embodiment of the present invention.

As illustrated in FIG. 7, a computer 110 includes a CPU 111, a main memory 112, a storage 113, an input interface 114, a display controller 115, a data reader/writer 116, and a communication interface 117. Each of these units is communicably connected to one another via a bus 121.

The CPU 111 develops programs (codes) which are stored in the storage device 113 in the main memory 112 in the present example embodiment, and performs various computations by performing the programs in a predetermined order. The main memory 112 is typically a volatile storage device such as a dynamic random access memory (DRAM). Further, the program according to the present example embodiment is provided in a state of being stored in a recording medium 120 that is computer-readable. Note that the program according to the present example embodiment may be circulated on the Internet connected via the communication interface 117.

Further, specific examples of the storage device 113 include a semiconductor storage device such as a flash memory, in addition to a hard disk drive. The input interface 114 mediates data transmission between the CPU 111 and an input instrument 118 such as a keyboard and a mouse. The display controller 115 is connected to a display device 119 and controls display on the display device 119.

The data reader/writer 116 mediates data transmission between the CPU 111 and the recording medium 120, and performs reading of the program from the recording medium 120 and writing of a processing result in the computer 110 to the recording medium 120. The communication interface 117 mediates data transmission between the CPU 111 and another computer.

Further, a specific example of the recording medium 120 includes a general-purpose semiconductor storage device such as Compact Flash (registered trademark) (CF) and a secure digital (SD), a magnetic storage medium such as a flexible disk, or an optical storage medium such as a compact disk read only memory (CD-ROM).

Note that the scheduled passenger guidance device according to the present example embodiment can also be achieved by using hardware corresponding to each of the units, instead of a computer on which a program is installed. Furthermore, a part of the scheduled passenger guidance device may be achieved by a program, and the rest of the scheduled passenger guidance device may be achieved by hardware. Further, the recording medium 120 in which a program is stored is also included in the present example embodiment.

A part or the whole of the above-mentioned example embodiment may also be described as in supplementary notes below, which is not limited thereto.

### (Supplementary Note 1)

A scheduled passenger guidance device that guides a scheduled passenger of an aircraft to an airport, the scheduled passenger guidance device comprising:

a flight number acquisition unit that acquires information on a flight number of an aircraft scheduled to be boarded by the scheduled passenger, the flight number being input from a terminal device;

a flight information acquisition unit that acquires flight information including information on flight numbers and boarding times of a plurality of aircrafts for each airport;

a position information acquisition unit that acquires position information on the terminal device;

a boarding time acquisition unit that acquires information on a boarding time of the aircraft scheduled to be boarded by the scheduled passenger using the information on the flight number of the aircraft acquired by the flight number acquisition unit and the flight information acquired by the flight information acquisition unit; and

a notification unit that provides a notification for the terminal device, the notification urging the scheduled passenger to board an aircraft and being based on the information on the boarding time acquired by the boarding time acquisition unit and the position of the terminal device acquired by the position information acquisition unit.

### (Supplementary Note 2)

The scheduled passenger guidance device according to supplementary note 1, wherein the notification unit calculates a distance between an airport at which the aircraft scheduled to be boarded by the scheduled passenger waits and a current position of the scheduled passenger using the information on the flight number of the aircraft acquired by the flight number acquisition unit, the flight information acquired by the flight information acquisition unit, and the position information acquired by the position information acquisition unit, and notifies the terminal device of a time at which the scheduled passenger needs to depart for the airport from the current position, the time depending on the calculated distance.

### (Supplementary Note 3)

The scheduled passenger guidance device according to supplementary note 1, further comprising

a traffic information acquisition unit that acquires traffic information, wherein

the notification unit determines a traffic route from a current position of the scheduled passenger to an airport at which the aircraft scheduled to be boarded by the scheduled passenger waits using the information on the flight number of the aircraft acquired by the flight number acquisition unit, the flight information acquired by the flight information acquisition unit, the position information acquired by the position information acquisition unit, and the traffic information acquired by the traffic information acquisition unit, and notifies the terminal device of the traffic route.

### (Supplementary Note 4)

The scheduled passenger guidance device according to any one of supplementary notes 1 to 3, further comprising

an airport situation acquisition unit that acquires congestion information indicating a congestion situation of each airport, wherein

the notification unit notifies the terminal device of a time at which the scheduled passenger needs to depart for an airport from a current position, the time being based on the congestion information acquired by the airport situation acquisition unit.

### (Supplementary Note 5)

The scheduled passenger guidance device according to any one of supplementary notes 1 to 4, wherein

the flight information includes vacant seat information each aircraft, and

the notification unit determines whether a delay occurs for the aircraft scheduled to be boarded by the scheduled passenger using the flight information acquired by the flight information acquisition unit, and, when the delay occurs, notifies the terminal device of a flight number and a boarding time of another aircraft having a vacant seat.

### (Supplementary Note 6)

The scheduled passenger guidance device according to any one of supplementary notes 1 to 5, wherein

the flight information includes information indicating a boarding gate of each aircraft, and

the notification unit notifies the terminal device of a route, the route is a route from a current position of the scheduled passenger to the boarding gate of the aircraft scheduled to be boarded by the scheduled passenger in a terminal building and is based on information on a preregistered floor map of the terminal building for each airport, the flight information acquired by the flight information acquisition unit, and the position information acquired by the position information acquisition unit.

### (Supplementary Note 7)

A scheduled passenger guidance method for guiding a scheduled passenger of an aircraft to an airport, the scheduled passenger guidance method comprising:

acquiring information on a flight number of an aircraft scheduled to be boarded by the scheduled passenger, the flight number being input from a terminal device;

acquiring flight information including information on flight numbers and boarding times of a plurality of aircrafts for each airport;

acquiring position information on the terminal device;

acquiring information on a boarding time of the aircraft scheduled to be boarded by the scheduled passenger using the information on the flight number of the aircraft and the flight information; and

providing a notification for the terminal device, the notification urging the scheduled passenger to board an aircraft and being based on the information on the boarding time and the position of the terminal device.

### (Supplementary Note 8)

The scheduled passenger guidance method according to supplementary note 7, wherein, when providing the notification,

calculating a distance between an airport at which the aircraft scheduled to be boarded by the scheduled passenger waits and a current position of the scheduled passenger using the information on the acquired flight number of the aircraft, the flight information and the position information, and

notifying the terminal device of a time at which the scheduled passenger needs to depart for the airport from the current position, the time depending on the calculated distance.

### (Supplementary Note 9)

The scheduled passenger guidance method according to supplementary note 7, further comprising

acquiring traffic information;

determining a traffic route from a current position of the scheduled passenger to an airport at which the aircraft scheduled to be boarded by the scheduled passenger waits using the information on the acquired flight number of the aircraft, the flight information, the position information and the traffic information; and

when providing the notification, notifying the terminal device of the traffic route.

### (Supplementary Note 10)

The scheduled passenger guidance method according to any one of supplementary notes 7 to 9, further comprising

acquiring congestion information indicating a congestion situation of each airport; and

when providing the notification, notifying the terminal device of a time at which the scheduled passenger needs to depart for an airport from a current position, the time being based on the acquired congestion information.

### (Supplementary Note 11)

The scheduled passenger guidance method according to any one of supplementary notes 7 to 10, wherein

the flight information includes vacant seat information each aircraft,

the scheduled passenger guidance method further comprising

determining whether a delay occurs for the aircraft scheduled to be boarded by the scheduled passenger using the acquired flight information, and,

when the delay occurs, notifying the terminal device of a flight number and a boarding time of another aircraft having a vacant seat.

### (Supplementary Note 12)

The scheduled passenger guidance method according to any one of supplementary notes 7 to 11, wherein

the flight information includes information indicating a boarding gate of each aircraft,

the scheduled passenger guidance method further comprising

notifying the terminal device of a route, the route is a route from a current position of the scheduled passenger to the boarding gate of the aircraft scheduled to be boarded by the scheduled passenger in a terminal building and is based on information on a preregistered floor map of the terminal building for each airport, the acquired flight information and the acquired position information.

### (Supplementary Note 13)

A program recording medium recording a computer program that makes a computer guide a scheduled passenger of an aircraft to an airport, the computer program causing the computer to execute:

acquiring information on a flight number of an aircraft scheduled to be boarded by the scheduled passenger, the flight number being input from a terminal device;

acquiring flight information including information on flight numbers and boarding times of a plurality of aircrafts for each airport;

acquiring position information on the terminal device;

acquiring information on a boarding time of the aircraft scheduled to be boarded by the scheduled passenger using the information on the flight number of the aircraft and the flight information; and

providing a notification for the terminal device, the notification urging the scheduled passenger to board an aircraft and being based on the information on the boarding time and the position of the terminal device.

### (Supplementary Note 14)

The program recording medium according to supplementary note 13, wherein the computer program causes the computer to execute,

when providing the notification,

calculating a distance between an airport at which the aircraft scheduled to be boarded by the scheduled passenger waits and a current position of the scheduled passenger using the information on the acquired flight number of the aircraft, the flight information and the position information, and

notifying the terminal device of a time at which the scheduled passenger needs to depart for the airport from the current position, the time depending on the calculated distance.

### (Supplementary Note 15)

The program recording medium according to supplementary note 13, wherein the computer program causes further the computer to execute,

acquiring traffic information;

determining a traffic route from a current position of the scheduled passenger to an airport at which the aircraft scheduled to be boarded by the scheduled passenger waits using the information on the acquired flight number of the aircraft, the flight information, the position information and the traffic information; and

when providing the notification, notifying the terminal device of the traffic route.

### (Supplementary Note 16)

The program recording medium according to any one of supplementary notes 13 to 15, wherein the computer program causes further the computer to execute,

acquiring congestion information indicating a congestion situation of each airport; and

when providing the notification, notifying the terminal device of a time at which the scheduled passenger needs to depart for an airport from a current position, the time being based on the acquired congestion information.

### (Supplementary Note 17)

The program recording medium according to any one of supplementary notes 13 to 16, wherein

the flight information includes vacant seat information each aircraft, and

wherein the computer program causes further the computer to execute,

determining whether a delay occurs for the aircraft scheduled to be boarded by the scheduled passenger using the acquired flight information, and,

when the delay occurs, notifying the terminal device of a flight number and a boarding time of another aircraft having a vacant seat.

### (Supplementary Note 18)

The program recording medium according to any one of supplementary notes 13 to 17, wherein

the flight information includes information indicating a boarding gate of each aircraft, and

wherein the computer program causes further the computer to execute,

notifying the terminal device of a route, the route is a route from a current position of the scheduled passenger to the boarding gate of the aircraft scheduled to be boarded by the scheduled passenger in a terminal building and is based on information on a preregistered floor map of the terminal building for each airport, the acquired flight information and the acquired position information.

Although the present invention has been described above with reference to the above-mentioned example embodiment and the like, the present invention is not limited to the above-described example embodiment. Various modifications that can be understood by those skilled in the art can be made to the configuration and the details of the present invention within the scope of the present invention.

This application is based upon and claims the benefit of priority from Japanese patent application No. 2016-249893 filed on Dec. 22, 2016, the disclosure of which is incorporated herein in its entirety by reference.

### INDUSTRIAL APPLICABILITY

As described above, according to the present invention, a scheduled passenger of an aircraft can be appropriately guided to an airport.

### REFERENCE SIGNS LIST

10: Flight number acquisition unit
12: Flight information acquisition unit
14: Position information acquisition unit
16: Boarding time acquisition unit
18: Notification unit
20: Airport situation acquisition unit

### 22: Storage

24: Traffic information acquisition unit
30: Terminal device
100: Scheduled passenger guidance device

### 110: Computer

### 111: CPU

112: Main memory

### 113: Storage

114: Input interface
115: Display controller
116: Data reader/writer
117: Communication interface
118: Input instrument
119: Display device
120: Recording medium

### 121: Bus

What is claimed is:

1. A scheduled passenger guidance device that guides a scheduled passenger of an aircraft to an airport, the scheduled passenger guidance device comprising:
a processor configured to:
acquire information on a flight number of an aircraft scheduled to be boarded by the scheduled passenger, the flight number being input from a terminal device;
acquire flight information including information on flight numbers and boarding times of a plurality of aircrafts for each airport;
acquire position information on the terminal device;
acquire information on a boarding time of the aircraft scheduled to be boarded by the scheduled passenger using the information on the flight number of the aircraft and the flight information; and
provide a notification for the terminal device, the notification urging the scheduled passenger to board an aircraft and being based on the information on the boarding time and the position of the terminal device.

2. The scheduled passenger guidance device according to claim 1, wherein the processor calculates a distance between an airport at which the aircraft scheduled to be boarded by the scheduled passenger waits and a current position of the scheduled passenger using the information on the flight number of the aircraft, the flight information, and the position information, and notifies the terminal device of a time at which the scheduled passenger needs to depart for the airport from the current position, the time depending on the calculated distance.

3. The scheduled passenger guidance device according to claim 1, wherein the processor is further configured to
acquire traffic information, and
wherein the processor determines a traffic route from a current position of the scheduled passenger to an airport at which the aircraft scheduled to be boarded by the scheduled passenger waits using the information on the flight number of the aircraft, the flight information, the position information, and the traffic information, and notifies the terminal device of the traffic route.

4. The scheduled passenger guidance device according to claim 1, wherein the processor is further configured to
acquire congestion information indicating a congestion situation of each airport, and
wherein the processor notifies the terminal device of a time at which the scheduled passenger needs to depart for an airport from a current position, the time being based on the congestion information.

5. The scheduled passenger guidance device according to claim 1, wherein
the flight information includes vacant seat information each aircraft, and
the processor determines whether a delay occurs for the aircraft scheduled to be boarded by the scheduled passenger using the flight information, and, when the delay occurs, notifies the terminal device of a flight number and a boarding time of another aircraft having a vacant seat.

6. The scheduled passenger guidance device according to claim 1, wherein
the flight information includes information indicating a boarding gate of each aircraft, and
the processor notifies the terminal device of a route, the route is a route from a current position of the scheduled passenger to the boarding gate of the aircraft scheduled to be boarded by the scheduled passenger in a terminal building and is based on information on a preregistered floor map of the terminal building for each airport, the flight information, and the position information.

7. A scheduled passenger guidance method for guiding a scheduled passenger of an aircraft to an airport, the scheduled passenger guidance method comprising:
by a processor,
acquiring information on a flight number of an aircraft scheduled to be boarded by the scheduled passenger, the flight number being input from a terminal device;
acquiring flight information including information on flight numbers and boarding times of a plurality of aircrafts for each airport;
acquiring position information on the terminal device;
acquiring information on a boarding time of the aircraft scheduled to be boarded by the scheduled passenger using the information on the flight number of the aircraft and the flight information; and
providing a notification for the terminal device, the notification urging the scheduled passenger to board an aircraft and being based on the information on the boarding time and the position of the terminal device.

8. The scheduled passenger guidance method according to claim 7, wherein, when providing the notification,
by the processor,
calculating a distance between an airport at which the aircraft scheduled to be boarded by the scheduled passenger waits and a current position of the scheduled passenger using the information on the acquired flight number of the aircraft, the flight information and the position information, and
notifying the terminal device of a time at which the scheduled passenger needs to depart for the airport from the current position, the time depending on the calculated distance.

9. The scheduled passenger guidance method according to claim 7, further comprising,
by the processor,
acquiring traffic information;
determining a traffic route from a current position of the scheduled passenger to an airport at which the aircraft scheduled to be boarded by the scheduled passenger waits using the information on the acquired flight number of the aircraft, the flight information, the position information and the traffic information; and
when providing the notification, notifying the terminal device of the traffic route.

10. The scheduled passenger guidance method according to claim 7, further comprising,
by the processor,
acquiring congestion information indicating a congestion situation of each airport; and
when providing the notification, notifying the terminal device of a time at which the scheduled passenger needs to depart for an airport from a current position, the time being based on the acquired congestion information.

11. The scheduled passenger guidance method according to claim 7, wherein
the flight information includes vacant seat information each aircraft,
the scheduled passenger guidance method further comprising,
by the processor,
determining whether a delay occurs for the aircraft scheduled to be boarded by the scheduled passenger using the acquired flight information, and,
when the delay occurs, notifying the terminal device of a flight number and a boarding time of another aircraft having a vacant seat.

12. The scheduled passenger guidance method according to claim 7, wherein
the flight information includes information indicating a boarding gate of each aircraft,
the scheduled passenger guidance method further comprising,
by the processor,
notifying the terminal device of a route, the route is a route from a current position of the scheduled passenger to the boarding gate of the aircraft scheduled to be boarded by the scheduled passenger in a terminal building and is based on information on a preregistered floor map of the terminal building for each airport, the acquired flight information and the acquired position information.

13. A non-transitory program recording medium recording a computer program that makes a computer guide a scheduled passenger of an aircraft to an airport, the computer program causing the computer to execute:
acquiring information on a flight number of an aircraft scheduled to be boarded by the scheduled passenger, the flight number being input from a terminal device;
acquiring flight information including information on flight numbers and boarding times of a plurality of aircrafts for each airport;
acquiring position information on the terminal device;
acquiring information on a boarding time of the aircraft scheduled to be boarded by the scheduled passenger using the information on the flight number of the aircraft and the flight information; and
providing a notification for the terminal device, the notification urging the scheduled passenger to board an aircraft and being based on the information on the boarding time and the position of the terminal device.

14. The non-transitory program recording medium according to claim 13, wherein the computer program causes the computer to execute,
when providing the notification,
calculating a distance between an airport at which the aircraft scheduled to be boarded by the scheduled passenger waits and a current position of the scheduled passenger using the information on the acquired flight number of the aircraft, the flight information and the position information, and
notifying the terminal device of a time at which the scheduled passenger needs to depart for the airport from the current position, the time depending on the calculated distance.

15. The non-transitory program recording medium according to claim 13, wherein the computer program causes further the computer to execute,
acquiring traffic information;
determining a traffic route from a current position of the scheduled passenger to an airport at which the aircraft scheduled to be boarded by the scheduled passenger waits using the information on the acquired flight number of the aircraft, the flight information, the position information and the traffic information; and
when providing the notification, notifying the terminal device of the traffic route.

16. The non-transitory program recording medium according to claim 13, wherein the computer program causes further the computer to execute,
acquiring congestion information indicating a congestion situation of each airport; and
when providing the notification, notifying the terminal device of a time at which the scheduled passenger needs to depart for an airport from a current position, the time being based on the acquired congestion information.

17. The non-transitory program recording medium according to claim 13, wherein
the flight information includes vacant seat information each aircraft, and
wherein the computer program causes further the computer to execute,
determining whether a delay occurs for the aircraft scheduled to be boarded by the scheduled passenger using the acquired flight information, and,
when the delay occurs, notifying the terminal device of a flight number and a boarding time of another aircraft having a vacant seat.

18. The non-transitory program recording medium according to claim 13, wherein
the flight information includes information indicating a boarding gate of each aircraft, and
wherein the computer program causes further the computer to execute,
notifying the terminal device of a route, the route is a route from a current position of the scheduled passenger to the boarding gate of the aircraft scheduled to be boarded by the scheduled passenger in a terminal building and is based on information on a preregistered floor map of the terminal building for each airport, the acquired flight information and the acquired position information.
